(19) United States
(12) Patent Application Publication
(10) Pub. No.: US 2008/0025274 A1
(43) Pub. Date: Jan. 31, 2008

(54) Method of generating a polling schedule for a wireless local area network

(76) Inventors: Jian Gang Cheng, Beijing (CN); Teh-Chao Chang Hsu, Beijing (CN); Guang Xuan Liu, Beijing (CN); Jun Wang, Shanghai (CN); Rong Qiang Zhang, Beijing (CN)

Correspondence Address: HARNESS, DICKEY & PIERCE, P.L.C., P.O. BOX 8910, RESTON, VA, 20195, US

(21) Appl. No.: 11/642,918

(22) Filed: Dec. 21, 2006

(30) Foreign Application Priority Data
Jul. 27, 2006 (CN) 200610108067.2

(51) Int. Cl. H04Q 7/24

(52) U.S. Cl. 370/338

(57) ABSTRACT

A method of generating a polling schedule for a plurality of access points and a plurality of mobile devices within a wireless local area network (WLAN) operating in accordance with a wireless communication protocol is provided. In the example method, a first polling schedule for polling each of the plurality of mobile devices within a first number of time slots is first generated. The first polling schedule is configured such that the polling for each of the plurality of mobile devices does not allow the plurality of mobile devices to interfere with each other. Then, based on the first polling schedule, it is determined whether each of the plurality of mobile devices can be polled in fewer time slots than the first number of time slots without interfering with each other. Based on the results of the determining step, a second polling schedule for polling each of the plurality of mobile devices within a second number of time slots is generated if the determining step determines that each of the plurality of mobile devices can be polled in fewer time slots than the first number of time slots, the second polling schedule being a compressed version of the first polling schedule such that the second number of time slots is fewer than the first number of time slots.

### PRIORITY STATEMENT

This application claims priority under 35 U.S.C. § 119 to Chinese Patent Application No. 200610108067.2, filed on Jul. 27, 2006, in the Chinese Patent Office (CPO), the disclosure of which is incorporated herein in its entirety by reference.

### BACKGROUND OF THE INVENTION

1. Field of the Invention

Example embodiments of the present invention are related generally to a method of generating a polling schedule for a wireless local area network (WLAN), and more particularly to a method of generating a polling schedule for polling mobile devices within a WLAN.

2. Description of the Related Art

In WLANs, mobile devices use access points (APs) (e.g., a wireless router) to connect to wired networks and communicate with other hosts. An AP is typically equipped with an interface that connects to a wired network (e.g., via an Ethernet connection) and a wireless interface (e.g., IEEE 802.11 (b/g), 802.16 (d/e), Bluetooth, etc.) that communicates with mobile devices.

A coverage area of an AP operating indoors in accordance with 802.11 is limited to approximately 200 to 300 feet. Additional APs may be used to expand the coverage area. When a mobile device moves from the coverage area of a first AP to a second AP, the handling of the mobile device's communications has to be “handed off” from the first AP to the second AP. In 802.11b, handoffs are initiated by the mobile device and occur at either layer-2 or layer-3 of a protocol stack.

For example, if the first and second APs function as MAC layer (layer-2) bridges, the handoff is performed only at layer-2 because both the first and second APs belong to the same IP subnet. In an alternative example, if the first and second APs function as IP (layer-3) routers, the first and second APs belong to different IP subnets. Thus, in addition to a layer-2 handoff, a layer-3 handoff is also necessary.

In WLANs intended for large coverage areas, seamless roaming support for mobile devices within the network is a desirable design criteria. In other Words, ensuring mobility of mobile devices throughout the WLAN coverage area without any service disruptions is desired. Thus, transport and application level sessions should not be disrupted during handoffs between APs. Real-time applications (e.g., VOIP, streaming audio and/or video, etc.) require that handoffs (e.g., layer-2 and/or layer-3 handoffs) be performed fast enough to avoid service disruption. For example, disruptions in a VOIP call would be noticed if the “jitter” is above a time threshold (e.g., 50 milliseconds (ms)). Thus, to support VOIP in 802.11 WLANs and avoid service disruption (e.g., jitter), handoffs must be performed in less time than the jitter time threshold.

Conventional mobile devices within 802.11 WLAN networks perform layer-2 handoffs in accordance with a break-before-make approach, alternatively referred to as “hard handoff”. In a hard handoff, a radio card (e.g., a PCMCIA wireless 802.11b card, etc.) on the mobile device begins probing for available neighboring APs with acceptable signal strengths if a signal strength of the connection with the serving AP drops below a signal strength threshold. In an example, 802.11b WLANs include 11 channels which may be probed for available APs, where a probing of all 11 channels may take up to a second to complete. Once an acceptable AP is discovered through the probing step, the mobile device authenticates with the new AP and then associates with the new AP by performing a layer-2 association. While still significant, delays associated with the associating and authenticating steps (e.g., 10 ms) are typically less than delays associated with the probing step (e.g., up to 1 second).

APs in conventional WLANs each transmit on one of a plurality of channels (e.g., 11 channels in 802.11b), with neighboring APs typically transmitting on different channels to reduce outer-cell interference (e.g., interference received at a local AP from a neighbor AP or mobile devices served by a neighbor AP). APs in conventional WLANs also typically have different machine access code (MAC) addresses and different basic service set identifiers (BSSIDs), so the mobile device can distinguish between different APs (e.g., to select a new AP to connect to, etc.). In conventional WLANs, it is important for each mobile device to be able to distinguish between neighboring APs in order to select a new AP to handoff to (i.e., “hard” handoff) if a connection with a currently serving AP drops below a connection strength threshold (e.g., a signal strength level below which a connection cannot be maintained).

The above-described probing, authenticating and associating steps may take a substantial amount of time (e.g., hundreds of milliseconds) which may vary based in part on the type of radio card being used. Further, if required, layer-3 handoffs add additional handoff latencies (e.g., on the order of hundreds of milliseconds). The delays associated with layer-2 and layer-3 handoffs are often large enough to cause service disruption in real-time applications in 802.11 WLANs.

A conventional method of reducing the above-described probing delays includes reporting the presence of neighboring APs to each mobile device in the coverage area of a 802.11 WLAN. Thus, since particular APs are “static” and typically remain on the same channel, the probing step may be limited to channels associated with the APs reported to the mobile device. However, the above-described conventional AP reporting method requires maintenance and dissemination of information to the mobile devices in the coverage area, and further requires changes to 802.11 protocols and an active management of the AP reports. Also, even if the delays associated with probing are reduced, delays associated with authentication and association still remain.

### SUMMARY OF THE INVENTION

An example embodiment of the present invention is directed to a method of generating a polling schedule for a plurality of access points and a plurality of mobile devices within a wireless local area network (WLAN) operating in accordance with a wireless communication protocol, including first generating a first polling schedule for polling each of the plurality of mobile devices within a first number of time slots, the first polling schedule configured such that the polling for each of the plurality of mobile devices does not allow the plurality of mobile devices to interfere with each other, determining, based on the first polling schedule, whether each of the plurality of mobile devices can be polled in fewer time slots than the first number of time slots without interfering with each other and second generating a second polling schedule for polling each of the plurality of mobile devices within a second number of time slots if the determining step determines that each of the plurality of mobile devices can be polled in fewer time slots than the first number of time slots, the second polling schedule being a compressed version of the first polling schedule such that the second number of time slots is fewer than the first number of time slots.

### BRIEF DESCRIPTION OF THE DRAWINGS

The present invention will become more fully understood from the detailed description given herein below and the accompanying drawings which are given by way of illustration only, wherein like reference numerals designate corresponding parts in the various drawings, and wherein:

FIG. 1 illustrates a wireless local area network (WLAN) according to an example embodiment of the present invention.

FIG. 2 illustrates a coverage area of an access point including a mobile device within the WLAN of FIG. 1 according to an example embodiment of the present invention.

FIG. 3 illustrates a call setup process for the mobile device performed at the access point of FIG. 2 according to an example embodiment of the present invention.

FIG. 4 illustrates a handoff process of a mobile device from a first access point to a second access point within the WLAN of FIG. 1 according to an example embodiment of the present invention.

FIG. 5 illustrates positions of the mobile device within the WLAN of FIG. 1 during different steps of the handoff process of FIG. 4.

FIG. 6 illustrates a portion of the WLAN system of FIG. 1 including a first access point, a second access point and a plurality of mobile devices according to another example embodiment of the present invention.

FIG. 7 illustrates another portion of the WLAN system including a plurality of access points and a plurality of mobile devices according to another example embodiment of the present invention.

FIG. 8 illustrates a polling optimization process according to another example of the present invention.

### DETAILED DESCRIPTION OF EXAMPLE EMBODIMENTS

In order to better understand the present invention, a description of a wireless local area network (WLAN) according to an example embodiment of the present invention is provided. Then, a call setup is described with respect to the example WLAN, followed by a handoff process performed within the example WLAN.

### Wireless Local Area Network (WLAN) System

As discussed in the Background of the Invention section, APs in conventional WLANs each transmit on one of a plurality of channels, with neighboring APs typically transmitting on different channels to reduce outer-cell interference, or interference received at a local AP from a neighboring cell (e.g., from a neighbor AP and/or mobile devices being served by a neighbor AP). APs in conventional WLANs also typically have different machine access code (MAC) addresses and different basic service set identifiers (BSSIDs). As will now be described in greater detail, WLANs according to example embodiments of the present invention include APs which communicate over the same channel and with the same MAC address and BSSID such that, from the perspective of a mobile device within the WLAN, all of the APs are the same.

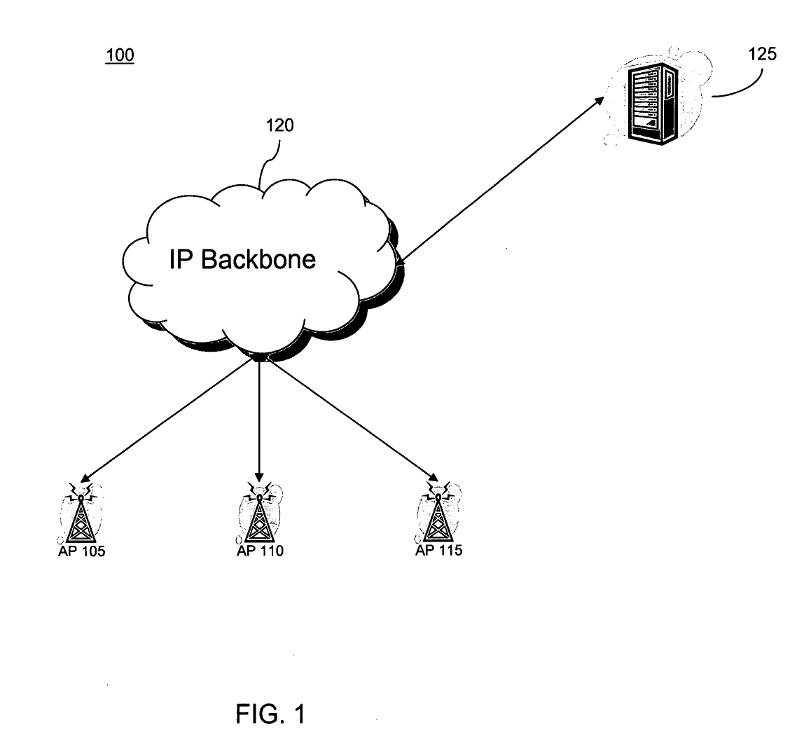

FIG. 1 illustrates a wireless local area network (WLAN) 100 according to an example embodiment of the present invention. In the example embodiment of FIG. 1, the WLAN 100 includes access points (APs) 105, 110 and 115, an internet protocol (IP) backbone 120 and a master controller (MC) 125. The APs 105/110/115 have overlapping coverage areas to reduce “gaps” in services provided to mobile devices (not shown). The APs 105/110/115 provide services to mobile devices within their respective coverage area over a wireless or air interface with any well-known wireless communication protocol, such as 802.11(a/b/g), 802.16e, Bluetooth, etc. The APs 105/110/115 are each further connected to the IP Backbone 120 over a wired connection or interface. The IP Backbone 120 is a switch that connects the WLAN 100 to an edge router, through which the WLAN 100 is connected to the Internet. The IP Backbone 120 is connected to the master controller 125 over a wired connection or interface.

The APs 105, 110 and 115 each communicate on the same channel (i.e., frequency range or bandwidth) and are assigned the same MAC address and the same BSSID. As will now be described, the uniformity of the APs 105, 110 and 115 within the WLAN 100 allows handoff support to be “offloaded” from mobile devices being served by the APs 105/110/115 to the master controller 125.

### Call Setup within the WLAN System

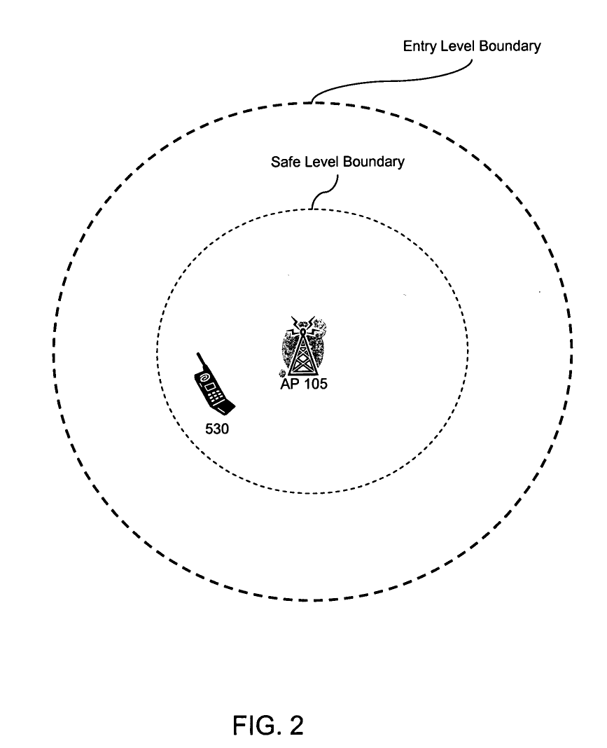

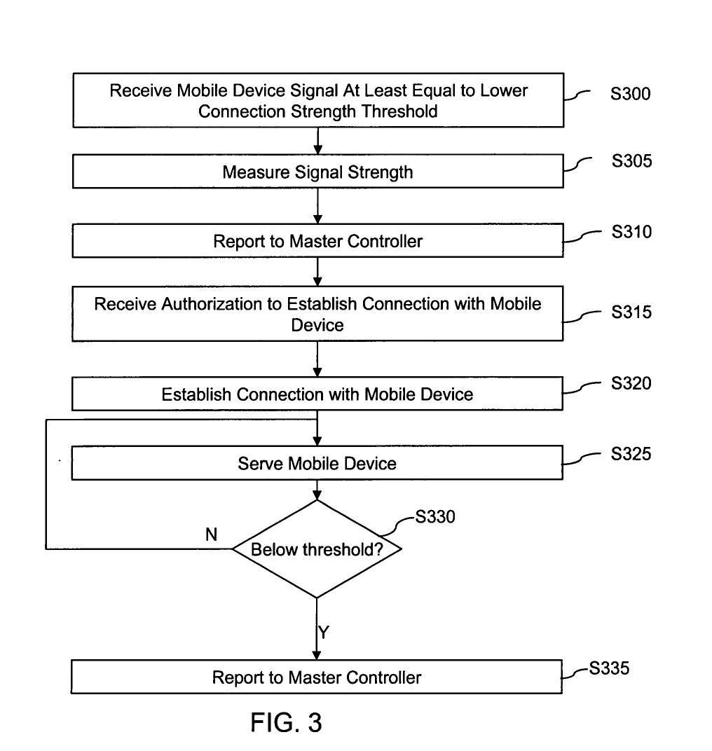

An example of call setup will now be described with reference to FIGS. 2 and 3 and the WLAN system 100 of FIG. 1.

FIG. 2 illustrates a coverage area of AP 105 including a mobile device 530 according to an example embodiment of the present invention. The coverage area of AP 105 includes a first coverage area bounded by an entry level boundary and a second coverage area bounded by a safe level boundary. Hereinafter, the first coverage area shall be referred to as an “entry level boundary region” and the second coverage area shall be referred to as a “safe level boundary region”.

In order to facilitate handoffs of mobile devices (e.g., mobile device 530) from a first AP (e.g., AP 105) to a second AP (e.g., AP 110) within the WLAN 100, the MC 125 defines a lower connection strength threshold and a higher connection strength threshold for each AP within the WLAN 100. Referring to FIG. 2, mobile devices being served by the AP 105 and positioned further away from the AP 105 generally have lower connection strengths than mobile devices positioned closer to the AP 105.

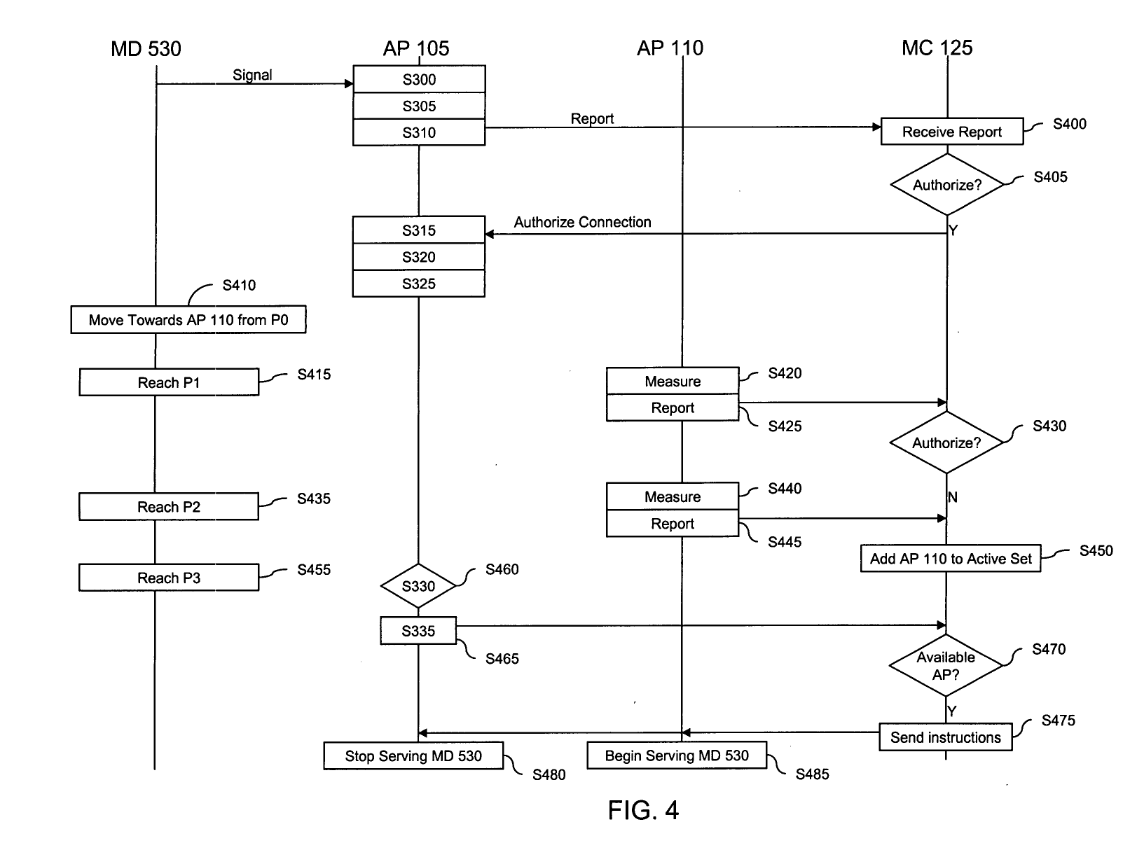

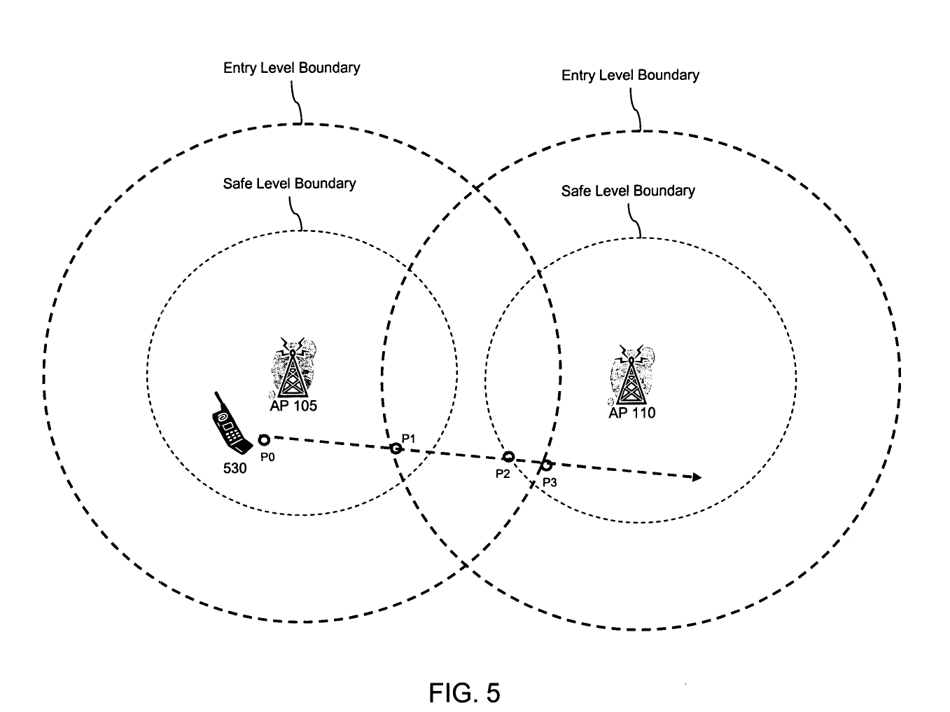

As shown in FIG. 2, the entry level boundary region includes mobile devices 530 with connection strengths above the lower connection strength threshold and the safe level boundary region includes mobile devices 530 with connection strengths above the higher connection strength threshold. The safe level boundary region is not used during call setup, and will be discussed in greater detail later with respect to call handoff and FIGS. 4 and 5.

In the example embodiment of FIG. 2, the mobile device 530 may be any well-known mobile device, including but not limited to a personal computer (PC), a notebook or laptop computer, a cellular phone, a PDA, a video game unit (e.g., a Playstation portable (PSP), a Nintendo DS, etc.), and/or any other well-known device capable of wireless communication.

FIG. 3 illustrates a call setup process for the mobile device 530 performed at AP 105 according to an example embodiment of the present invention. The call setup process of FIG. 3 will hereinafter be described with reference to FIG. 2. Within the process of FIG. 3, it is assumed that the mobile device 530 is new to the WLAN 100. In other words, the mobile device 530 is not being served by any AP other than AP 105 within the WLAN 100 during the process of FIG. 3.

In step S300 of FIG. 3, the AP 105 receives a signal from the mobile device 530. For example, the signal may be a mobile pilot signal, a request for services, etc. The AP 105 measures the signal strength of the received signal in step S305. In step S310, if the measured signal strength is greater than or equal to the lower connection strength threshold, the AP 105 sends a report to the MC 125 indicating that the mobile device has a signal strength at least equal to the lower connection strength threshold.

As discussed above, within the process of FIG. 3, it is assumed that the mobile device 530 requesting service in step S300 is not being served by any AP other than AP 105 within the WLAN 100 during the process of FIG. 3. Accordingly, in step S315 the AP 105 receives instructions from the MC 125 authorizing the AP 105 to establish a connection with the mobile device. The AP 105 establishes a connection with the mobile device 530 in step S320 according to conventional methods. As discussed in the Background of the Invention section, call setup typically includes probing, association and authentication. In step S320, probing is not necessary because the AP 105 is already monitoring signals from the mobile device 530. Thus, the AP 105 associates and authenticates the mobile device 530. Thereafter, in step S325, the AP 105 serves the mobile device 530 and continues to monitor the mobile device's 530 signal strength.

In step S330 of FIG. 3, the AP 105 determines whether the connection strength drops below the lower connection strength threshold. If the AP 105 determines that the connection strength with the mobile device 530 remains at least equal to the lower connection strength threshold, the process returns to step S325 and the AP 105 continues to serve (e.g., transfer data to/from) the mobile device. Remaining at or above the lower connection strength threshold implies that the mobile device 530 remains within the entry level boundary region of FIG. 2. Otherwise, if the AP 105 determines that the connection strength of the mobile device 530 drops below the lower connection strength threshold, the process advances to step S335. In step S335, the AP 105 reports the lowered connection status of the mobile device 530 to the MC 125. The reporting of the lowered connection status is treated by the MC 125 as a request to handoff the mobile device 530 to a neighboring AP, the handling of which will be described in greater detail later.

### Call Handoff in the WLAN System

FIG. 4 illustrates a handoff process of a mobile device 530 from the AP 105 to the AP 110 within the WLAN 100 according to an example embodiment of the present invention. FIG. 5 illustrates positions of the mobile device 530 within the WLAN 100 during different steps of the handoff process of FIG. 4.

In the example embodiment of FIG. 4, the mobile device 530 is initially positioned at position P0 of FIG. 5, which is within both the entry and safe level boundary regions of AP 105. The mobile device 530 establishes a connection with the AP 105 using the process described above with respect to FIG. 3. Accordingly, the mobile device 530 sends out a signal to request a connection, and the AP 105 performs steps S300 to S325 to establish the connection. While FIG. 3 is described from the perspective of the AP 105, FIG. 4 illustrates how the MC 125 is affected during steps S310 and S315 of FIG. 3. Thus, in step S310, the AP 105 sends the report to the MC 125 to indicate that the measured signal strength of signals received from the mobile device 530 is above the lower connection strength threshold (e.g., because the mobile device 530 is positioned within the entry level boundary region of the AP 105). In step S400, the MC 125 receives the report sent from the AP 105. In step S405, the MC 125 determines whether or not the mobile device 530 is currently being served by another AP within the WLAN 100. If the MC 125 determines that the mobile device 530 is currently being served by another AP within the WLAN 100, the MC 125 takes no action and no authorization to communicate with the mobile device 530 is granted to the AP 105. Alternatively, if the MC 125 determines that the mobile device 530 is not being served, the MC 125 sends a signal to the AP 105 which authorizes the AP 105 to establish a connection with the mobile device 530. The AP 105 receives the authorization (step S315 of FIG. 3), establishes the connection with the mobile device 530 (step S320 of FIG. 3) and serves (e.g., transfers data to/from) the mobile device 530 (step S325 of FIG. 3).

The AP 105 remains in step S325 and continues to serve the mobile device 530. Referring to FIG. 5, the mobile device 530 remains at position P0 during the above-described call connection setup. However, it is understood that, in other example embodiments, the mobile device 530 could establish a connection with the AP 105 anywhere within the entry level boundary region of the AP 105.

In step S410 of FIG. 4, the mobile device 530 begins moving towards the AP 110 from position P0 of FIG. 5. As shown in FIG. 5, the mobile device 530 moves along the line illustrated in FIG. 5, from position P0 to position P1. In step S415 of FIG. 4, the mobile device 530 reaches position P1 and enters the entry level boundary region of the AP 110. Accordingly, in step S420 of FIG. 4, the AP 110 receives and measures signals transmitted by the mobile device 530 at signal strengths at least equal to the lower connection strength threshold. In step S425, the AP 110 reports that the measured signal strength of the mobile device 530 is at least equal to the lower connection strength threshold to the MC 125.

In step S430, the MC 125 receives the report from the AP 110 and determines whether another AP is serving the mobile device 530. Because the AP 105 is already serving the mobile device 530, the MC 125 determines to take no action and does not authorize the AP 110 to establish a connection with the mobile device 530.

In step S435 of FIG. 4, the mobile device 530 reaches position P2 of FIG. 5. As shown in FIG. 5, at position P2, the mobile device 530 is still within the entry level boundary region of AP 105, but also enters the safe level boundary region of AP 110. Accordingly, in step S440, the AP 110 receives and measures transmissions sent by the mobile device 530 with signal strengths greater than or equal to the higher connection strength threshold. In step S445, the AP 110 reports to the MC 125 that the measured signal strength of signals received from the mobile device 530 are at least equal to the higher connection strength threshold.

In step S450 of FIG. 4, the MC 125 receives the report from the AP 110 (sent at step S445) and adds AP 110 to an active set for the mobile device 530. The active set is a list of APs capable of serving the mobile device 530. The active set is stored and updated at the MC 125 and is used to select alternate serving APs if a handoff becomes necessary, as will be described later in the process of FIG. 4.

In step S455 of FIG. 4, the mobile device 530 reaches position P3 of FIG. 5. As shown in FIG. 5, at position P3, the mobile device 530 is no longer within the entry level boundary region of AP 105, but remains within the safe level boundary region of AP 110. Accordingly, in step S460 of FIG. 4, the AP 105 determines that its connection strength with the mobile device 530 has fallen below the lower connection strength threshold (step S330 of FIG. 3). In step S465 of FIG. 4, the AP 105 reports the lowered connection status between the AP 105 and the mobile device 530 to the MC 125 (step S335 of FIG. 3).

In step S470, the MC 125 receives the lowered connection status report from the AP 105 and analyzes the active set for the mobile device 530 to determine whether another AP is available to serve the mobile device 530. Because the MC 125 added the AP 110 to the mobile device's 530 active set in step S450, the MC 125 determines that a handoff of the mobile device 530 from the AP 105 to the AP 110 is available. Accordingly, in step S475, the MC 125 sends handoff instructions to the AP 105 and the AP 110.

In step S480, the AP 105 receives the handoff instructions from the MC 125 and stops serving, or attempting to serve, the mobile device 530. In step S485, the AP 110 receives the handoff instructions from the MC 125 and begins serving the mobile device 530.

While not illustrated in FIG. 4, the AP 110 continues to monitor the signal strength of signals received from the mobile device 530 after step S450. If the measured signal strength falls below the higher connection strength threshold, the AP 110 reports the lowered signal strength to the MC 125. The MC 125 then removes AP 110 from the active set of the mobile device 530. Thus, the MC 125 cooperates with the APs 105/110/115 of the WLAN 100 so as to maintain a relatively up-to-date active set.

Further, as will be appreciated with respect to the handoff process of FIG. 4, the mobile device 530 is not aware of the handoff from the AP 105 to the AP 110. Rather, from the perspective of the mobile device 530, once a connection is established, the mobile device 530 assumes that its connection remains with the initial serving AP. Thus, legacy mobile devices can be employed within the WLAN system 100 and may receive the benefits of the above-described simplified handoff process.

### Interference Reduction in the WLAN System

As discussed above, each AP within the WLAN system 100 of FIG. 1 is configured to transmit on the same channel, whereas conventional WLAN systems typically include neighboring or adjacent APs transmitting on different channels to reduce outer-cell interference. Accordingly, the same-channel transmissions of the APs within the WLAN system 100 may cause increased system interference.

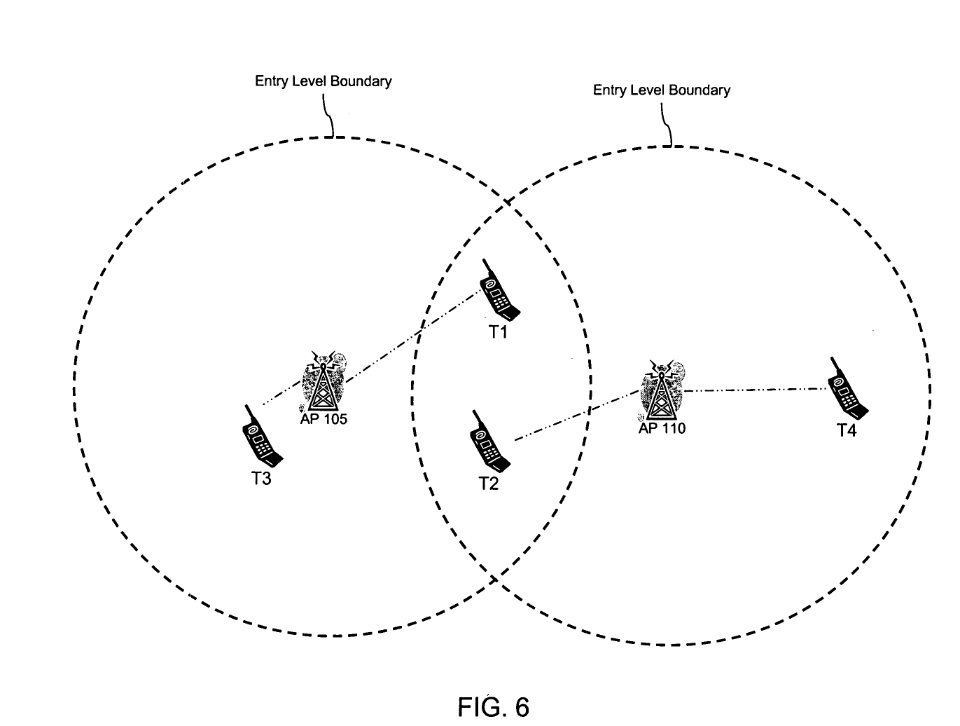

In order to reduce interference within the WLAN system 100, the MC 125 configures the APs within the WLAN system 100, as well as corresponding served mobile devices 530, to use time division in accordance with a point coordination function (PCF) mode. The PCF mode is a well-known polling protocol which partitions potential interferers into different time slots. Thus, the MC 125 configures each of its APs to poll potentially intersecting or interfering mobile devices during different time slots. The time slot partitioning of communication within the WLAN system 100 will now be described with respect to FIG. 6.

FIG. 6 illustrates a portion of the WLAN system 100 including APs 105 and 110 and mobile devices T1 through T4 according to another example embodiment of the present invention.

In the example embodiment of FIG. 6, the entry level boundary regions for APs 105 and 110 intersect. Mobile device T3 is positioned within a non-intersecting portion of the entry level boundary region for AP 105, mobile device T4 is positioned within a non-intersecting portion of the entry level boundary region for AP 110, and mobile devices T1 and T2 are positioned within an intersecting portion of the entry level boundary regions for AP 105 and AP 110.

Table 1 (below) illustrates an example polling schedule for the mobile terminals T1 through T4.

TABLE 1

| Time slot | AP 105 | AP 110 |
|---|---|---|
| Time slot 1 | Poll T1 | Standby (idle) |
| Time slot 2 | Standby (idle) | Poll T2 |
| Time slot 3 | Poll T3 | Poll T4 |

As shown in Table 1, the example polling schedule includes three (3) time slots. The three time slots repeat in succession such that each mobile device is polled and can access its serving AP at a given interval (e.g., at every third time slot). In time slot 1, mobile device T1 is polled by AP 105 while AP 110 is in “standby” mode. Because mobile device T1 is in the intersecting portion of the entry level boundary regions for AP 105 and AP 110, when the mobile device T1 is polled, the AP 110 cannot poll mobile devices without interfering with the polling of the mobile device T1. Accordingly, AP 110 remains in standby during time slot 1. In time slot 2, AP 105 remains in standby while AP 110 polls mobile device T2. In time slot 3, AP 105 polls mobile device T3 and AP 110 polls mobile device T4. Both mobile devices T3 and T4 are capable of simultaneous polling in time slot 3 because they are each positioned in non-intersecting portions of the entry level boundary regions of AP 105 and AP 110, respectively. In other words, because mobile devices T3 and T4 are non-intersecting, the mobile devices T3 and T4 can be simultaneously polled without interfering with each other. Simultaneous polling of non-intersecting mobile devices is desirable to reduce the number of required time slots.

Generally, in order to increase the bandwidth used by the WLAN system 100 and to reduce “standby” or idle times, the fewest number of time slots for the polling schedule (e.g., of Table 1) should be used. Accordingly, Table 1 represents a relatively simple optimized polling schedule for the two APs 105/110 and four mobile devices T1-T4 illustrated in the example embodiment of FIG. 6. However, in real-world applications, numerous access points may be deployed within a WLAN and a number of served mobile devices within the WLAN may likewise scale to very high numbers. Thus, a strategy of simply “eyeing” a coverage area map to establish an efficient polling schedule is typically impractical in real-world applications.

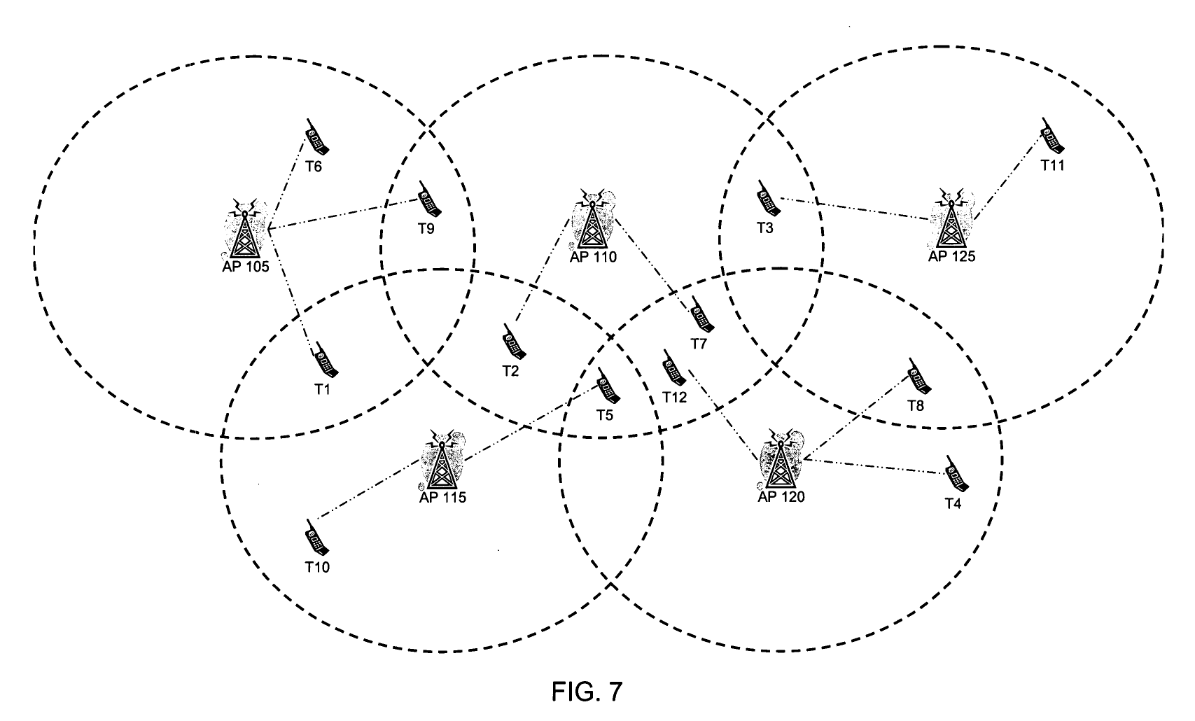

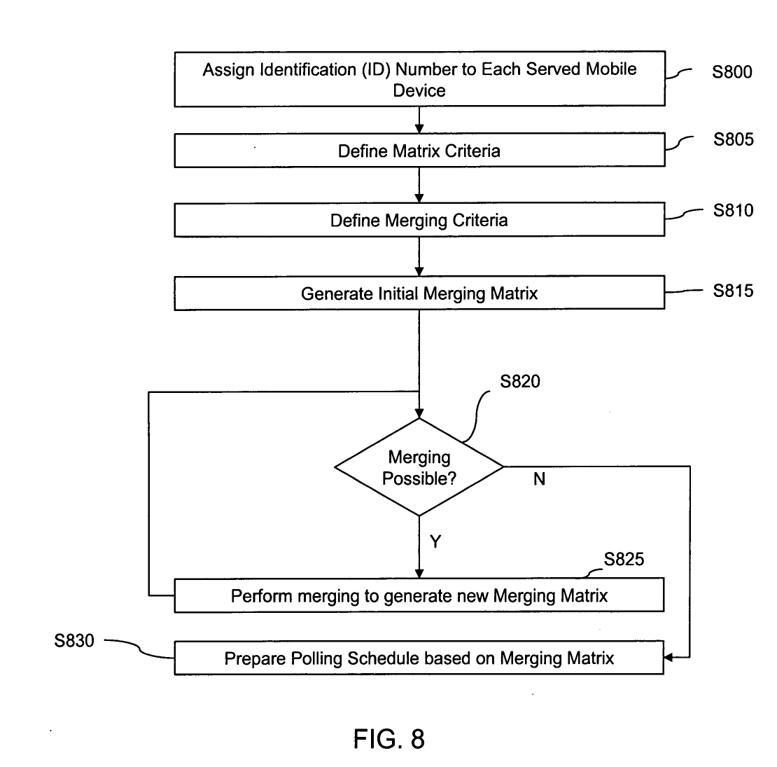

An example of a polling optimization process will now be described with respect to FIGS. 7 and 8.

FIG. 7 illustrates another portion of the WLAN system 100 including APs 105, 110, 115, 120 and 125 and mobile devices T1 through T12 according to another example embodiment of the present invention.

In the example embodiment of FIG. 7, each of the entry level boundary regions for APs 105 through 125 intersect with at least one of the other APs 105 through 125. Because of the larger number of APs being considered, Tables will be used to describe the relationship between APs 105 through 125 and mobile devices T1 through T12.

FIG. 8 illustrates a polling optimization process according to another example of the present invention. An implementation of the polling optimization process of FIG. 8 will be described below as being performed at the MC 125. The process of FIG. 8 is further described as optimizing the polling schedule of the APs 105 through 125 and mobile devices T1 through T12 as shown in FIG. 7. However, it is understood that the implementation of the process of FIG. 8 as herein described is for example purposes only, and the process of FIG. 8 may be alternatively configured to optimize a polling schedule for numerous other WLAN arrangements.

In step S800 of FIG. 8, the MC 125 assigns a unique identification (ID) number to each mobile device T1-T12 being served within the WLAN 100. For example, the ID numbers may be assigned as shown below in Table 2:

TABLE 2

| | T1 | T2 | T3 | T4 | T5 | T6 | T7 | T8 | T9 | T10 | T11 | T12 |
|---|---|---|---|---|---|---|---|---|---|---|---|---|
| ID# | 101 | 201 | 301 | 401 | 501 | 102 | 202 | 402 | 103 | 502 | 302 | 403 |

Next, the MC 125 defines matrix criteria in step S805. The matrix criteria includes a set of assumptions for establishing rows and columns in a table format. The table format conforms with a merging algorithm, which will be described below. The merging algorithm collapses or reduces a number of columns within the initially established matrix into an “optimized” form. Once established, the matrix criteria is used to generate an initial “merging matrix”, which will be described in greater detail later with respect to step S815 of FIG. 8. Generally, the merging matrix is a table including a plurality of cells. The table includes a plurality of rows and columns, with each of the plurality of cells being referenced by (Row #, Column #). In step S805, the matrix criteria is the following:

One row is allocated to each of the APs 105 through 125. The row allocations do not change during the subsequent merging process (steps S820 through S825 of FIG. 8);

One column is initially allocated to each mobile device T1 through T12. The initial column allocations may change during the subsequent merging process, such that after the merging process, columns are not necessarily associated with individual mobile devices;

A cell intersecting a mobile device's column and a row allocated to an AP serving the mobile device is assigned the ID Number of the mobile device (from step S800);

A cell intersecting with a mobile device's column and a row allocated to an AP, other than the AP serving the mobile device, having an entry level boundary region within which the mobile device is positioned is assigned a value of “1”; and

A cell intersecting with a mobile device's column and a row allocated to an AP which does not include the mobile device within its entry level boundary region is assigned a value of “0”.

In step S810 of FIG. 8, the MC 125 defines merging criteria which is used to “merge” columns within the merging matrix. While many possible merging parameters may be included within the merging criteria used to optimize the merging matrix, for the purposes of describing the example embodiment of FIG. 8, the merging criteria shall be defined as follows:
Merge two or more mobile devices into a single column if the two or more mobile devices are capable of being polled simultaneously. Generally, mobile devices are capable of simultaneous polling in a time slot if they are each positioned in non-intersecting portions of entry level boundary regions of different APs. Mathematically, this means merging two columns if cells within a same row of the two columns meet one of a plurality of merging transformation. The plurality of merging transformations, which will now be given, are provided in a format of:
[Value of Cell in (Column X, Row i), Value of Cell in (Column Y, Row i)],
wherein X and Y refer to different numbered columns and i refers to the same row within each of columns X and Y. Then, a resultant merged value is provided for the resultant “merged” column. Accordingly, the merging transformations are as follows:
[0, 0] transforms to “0”;
[0, 1] or [1, 0] transforms to “1”;
[1, 1] transforms to “1”; and
[0, ID Number] or [ID Number, 0] transforms to “ID Number”.

[1, ID Number], [ID Number, 1] or [ID Number, ID Number] does not transform and columns X and Y do not merge.

Once the MC 125 has assigned unique ID numbers for each of the plurality of mobile devices T1 through T12 (step S800) and defined matrix criteria (step S805) and merging criteria (step S810), the MC 125 is ready to generate and optimize the merging matrix.

In step S815 of FIG. 8, the MC 125 generates an initial merging matrix in accordance with the assigned unique ID Numbers (step S800) and the defined matrix criteria (step S805). For the example embodiment illustrated in FIG. 7, the initial merging matrix is shown below in Table 3.

TABLE 3

| | 1 | 2 | 3 | 4 | 5 | 6 | 7 | 8 | 9 | 10 | 11 | 12 |
|---|---|---|---|---|---|---|---|---|---|---|---|---|
| 1 | 101 | 0 | 0 | 0 | 0 | 102 | 0 | 0 | 103 | 0 | 0 | 0 |
| 2 | 0 | 201 | 1 | 0 | 1 | 0 | 202 | 0 | 1 | 0 | 0 | 1 |
| 3 | 0 | 0 | 301 | 0 | 0 | 0 | 0 | 1 | 0 | 0 | 302 | 0 |
| 4 | 0 | 0 | 0 | 401 | 1 | 0 | 1 | 402 | 0 | 0 | 0 | 403 |
| 5 | 1 | 1 | 0 | 0 | 501 | 0 | 0 | 0 | 0 | 502 | 0 | 0 |

The merging matrix of Table 3 is “un-optimized” such that each of columns 1 through 12 correspond to mobile devices T1 through T12, respectively. In other words, if one were to simply use Table 3 as a polling schedule, twelve (12) time slots would be required to poll each of mobile devices T1 through T12, with each column corresponding to a time slot. Accordingly, it will be appreciated that such a tactic is inefficient if merges (i.e., column reductions) are possible. Rows 1 through 5 correspond with APs 105 through 125, respectively. However, unlike the columns 1 through 12, rows 1 through 5 correspond with APs 105 through 125 throughout the subsequent merging process.

In step S820, the MC 125 evaluates the initial merging matrix generated in step S815 to determine whether one or more column merges are possible. If each cell in a first column satisfies the merging criteria, as above described, for a transformation, with each cell in the same row of a second column, then a merge is considered to be possible. In other words, if the conditions [ID Number, 1] and [1, ID Number] do not occur in any pair of cells belonging to the same rows in the first and second columns, then the first and second columns may merge. Alternatively, if one or more of the conditions [ID Number, 1] and [1, ID Number] occur in any pair of cells belonging to the same rows in the first and second columns, then the first and second columns may not merge.

As will now be described, column merges will be described as being performed “from left to right”. In other words, a first available pair of mergeable columns will be assumed to include the two left-most columns for which merging is possible, wherein “left-most” means that a higher of two mergeable columns is minimized (e.g., such that a column merge of columns 4 and 5 is “left” compared to a column merge of 3 and 11, etc.). However, it is understood that the merging process may be performed in alternative ways, such as “from right to left”, or even at random. Accordingly, applying the merging criteria defined in step S810, the MC 125 determines that a merging of columns 1 and 2 may be performed, and the process advances to step S825.

In S825, the MC 125 performs the merging of two columns of the initial merging matrix. The merging of step S825 is performed as shown below in Table 4 (below).

TABLE 4

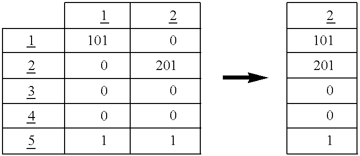

As shown in Table 4 (above), columns 1 and 2 are merged to a resultant column 2 in accordance with the merging criteria established in step S810. Table 5 (below) illustrates the merging matrix after performing the above-described “first iteration” of the merging step S825.

TABLE 5

| | 2 | 3 | 4 | 5 | 6 | 7 | 8 | 9 | 10 | 11 | 12 |
|---|---|---|---|---|---|---|---|---|---|---|---|
| 1 | 101 | 0 | 0 | 0 | 102 | 0 | 0 | 103 | 0 | 0 | 0 |
| 2 | 201 | 1 | 0 | 1 | 0 | 202 | 0 | 1 | 0 | 0 | 1 |
| 3 | 0 | 301 | 0 | 0 | 0 | 0 | 1 | 0 | 0 | 302 | 0 |
| 4 | 0 | 0 | 401 | 1 | 0 | 1 | 402 | 0 | 0 | 0 | 403 |
| 5 | 1 | 0 | 0 | 501 | 0 | 0 | 0 | 0 | 502 | 0 | 0 |

After the merging step S825, the process returns to step S820. To simplify the description of the iterative merging process of FIG. 8, subsequent iterations of step S825 will now be described with the assumption that step S820 is performed first to ensure that additional merges are possible.

Accordingly, after step S820 determines that another merge is available, the process advances to a second iteration of step S825. In the second iteration of the merging step S825, columns 2 and 4 from Table 5 merge to a resultant column 3. In addition, because column 4 is merged into the resultant column 3, column 3 from Table 5 is “bumped up” to a resultant column 4. Further, in the second iteration of the merging step S825, the two left-most columns (i.e., columns 2 and 3) do not merge because [201, 1] for row #2 does not meet the merging criteria defined above in step S810, and as such, step S820 would not determine that a merge of columns 2 and 3 is possible. Table 6 (below) illustrates the merging matrix after performing the second iteration of the merging step S825.

TABLE 6

| | 3 | 4 | 5 | 6 | 7 | 8 | 9 | 10 | 11 | 12 |
|---|---|---|---|---|---|---|---|---|---|---|
| 1 | 101 | 0 | 0 | 102 | 0 | 0 | 103 | 0 | 0 | 0 |
| 2 | 201 | 1 | 1 | 0 | 202 | 0 | 1 | 0 | 0 | 1 |
| 3 | 0 | 301 | 0 | 0 | 0 | 1 | 0 | 0 | 302 | 0 |
| 4 | 401 | 0 | 1 | 0 | 1 | 402 | 0 | 0 | 0 | 403 |
| 5 | 1 | 0 | 501 | 0 | 0 | 0 | 0 | 502 | 0 | 0 |

In a third iteration of the merging step S825, columns 4 and 5 from Table 6 merge to a resultant column 5 (e.g., because a merge with column 3 and either of columns 4 or 5 is not possible). Accordingly, because column 4 is merged into resultant column 3, column 3 from Table 6 is “bumped up” to a resultant column 4. Table 7 (below) illustrates the merging matrix after performing the third iteration of the merging step S825.

TABLE 7

| | 4 | 5 | 6 | 7 | 8 | 9 | 10 | 11 | 12 |
|---|---|---|---|---|---|---|---|---|---|
| 1 | 101 | 0 | 102 | 0 | 0 | 103 | 0 | 0 | 0 |
| 2 | 201 | 1 | 0 | 202 | 0 | 1 | 0 | 0 | 1 |
| 3 | 0 | 301 | 0 | 0 | 1 | 0 | 0 | 302 | 0 |
| 4 | 401 | 1 | 0 | 1 | 402 | 0 | 0 | 0 | 403 |
| 5 | 1 | 501 | 0 | 0 | 0 | 0 | 502 | 0 | 0 |

Hereinafter, iterations four through seven of the merging step S825 will be illustrated in the forms of resultant merging matrixes in Tables 8 through 11, respectively, for the sake of brevity, without a further description thereof. The column merges shown below in Tables 8 through 11 will be readily apparent in view of the description above.

TABLE 8

| | 5 | 6 | 7 | 8 | 9 | 10 | 11 | 12 |
|---|---|---|---|---|---|---|---|---|
| 1 | 101 | 102 | 0 | 0 | 103 | 0 | 0 | 0 |
| 2 | 201 | 1 | 202 | 0 | 1 | 0 | 0 | 1 |
| 3 | 0 | 301 | 0 | 1 | 0 | 0 | 302 | 0 |
| 4 | 401 | 1 | 1 | 402 | 0 | 0 | 0 | 403 |
| 5 | 1 | 501 | 0 | 0 | 0 | 502 | 0 | 0 |

TABLE 9

| | 6 | 7 | 8 | 9 | 10 | 11 | 12 |
|---|---|---|---|---|---|---|---|
| 1 | 101 | 102 | 0 | 103 | 0 | 0 | 0 |
| 2 | 201 | 1 | 202 | 1 | 0 | 0 | 1 |
| 3 | 0 | 301 | 0 | 1 | 0 | 302 | 0 |
| 4 | 401 | 1 | 1 | 402 | 0 | 0 | 403 |
| 5 | 1 | 501 | 0 | 0 | 502 | 0 | 0 |

TABLE 10

| | 7 | 8 | 9 | 10 | 11 | 12 |
|---|---|---|---|---|---|---|
| 1 | 101 | 102 | 0 | 103 | 0 | 0 |
| 2 | 201 | 1 | 202 | 1 | 0 | 1 |
| 3 | 0 | 301 | 0 | 1 | 302 | 0 |
| 4 | 401 | 1 | 1 | 402 | 0 | 403 |
| 5 | 1 | 501 | 0 | 502 | 0 | 0 |

TABLE 11

| | 8 | 9 | 10 | 11 | 12 |
|---|---|---|---|---|---|
| 1 | 101 | 102 | 0 | 103 | 0 |
| 2 | 201 | 1 | 202 | 1 | 1 |
| 3 | 302 | 301 | 0 | 1 | 0 |
| 4 | 401 | 1 | 1 | 402 | 403 |
| 5 | 1 | 501 | 0 | 502 | 0 |

After achieving the merging matrix illustrated above in Table 11 in the seventh iteration of the merging step S825, the process returns to step S820 and the MC 125 determines that no additional merges are possible (e.g., because no pair of columns meet the merging criteria in each respective rows). The process of FIG. 8 advances to step S830 where the merging matrix is “cleaned up” such that only ID Numbers and “0” values remain in the merging matrix. In other words, the “1” values are removed from the merging matrix of Table 11 in step S830, as shown in resultant Table 12 (below).

TABLE 12

| | 8 | 9 | 10 | 11 | 12 |
|---|---|---|---|---|---|
| 1 | 101 | 102 | 0 | 103 | 0 |
| 2 | 201 | 0 | 202 | 0 | 0 |
| 3 | 302 | 301 | 0 | 0 | 0 |
| 4 | 401 | 0 | 0 | 402 | 403 |
| 5 | 0 | 501 | 0 | 502 | 0 |

Table 12 (above) illustrates an optimized polling schedule for the example embodiment of FIG. 7. It is important to note that Table 12 does not necessarily illustrate the only possible optimized solution, but rather merely illustrates an example optimized solution arrived at based on the assumptions described above in steps S800 through S810. Accordingly, under different assumptions, a different optimized solution may be achieved.

The merging matrix illustrated in Table 12 may be interpreted as a polling schedule by treating each column as a time slot and treating rows 1 through 5 as APs 105 through 125, respectively. Accordingly, Table 12 may be alternatively presented in a more descriptive fashion as shown in Table 13 (below).

TABLE 13

| | Time | | | | |
|---|---|---|---|---|---|
| | Slot 1 | Time Slot 2 | Time Slot 3 | Time Slot 4 | Time Slot 5 |
| AP 105 | T1 | T6 | 0 | T9 | 0 |
| AP 110 | T2 | 0 | T7 | 0 | 0 |
| AP 115 | T11 | T3 | 0 | 0 | 0 |
| AP 120 | T4 | 0 | 0 | T8 | T12 |
| AP 125 | 0 | T5 | 0 | T10 | 0 |

Accordingly, referring to Table 13 (above), during time slot 1, AP 105 polls mobile device T1, AP 110 polls mobile device T2, AP 115 polls mobile device T11 and AP 120 polls mobile device T4. In time slot 2, AP 105 polls mobile device T6, AP 115 polls mobile device T3 and AP 125 polls mobile device T5. In time slot 3, AP 110 polls mobile device T7. In time slot 4, AP 105 polls mobile device T9, AP 120 polls mobile device T8 and AP 125 polls mobile device T10. In time slot 5, AP 120 polls mobile device T12.

Thus, the APs 105 through 125 transition through time slots 1 through 5 and poll mobile devices T1 through T12 in accordance with Table 13 repeatedly until the MC 125 updates the polling schedule. In an example, the MC 125 updates the polling schedule (1) if one or more of the mobile devices T1 through T12 is dropped, (2) if one or more of the mobile devices T1 through T12 is handed off to a different AP, (3) if a new mobile device is added to the WLAN or (4) if one or more of the mobile devices T1 through T12 moves to a new position which affects the polling schedule (e.g., from a position intersecting with one set of entry level boundary regions to a position intersecting with a different set of entry level boundary regions, etc.).

Example embodiments of the present invention being thus described, it will be obvious that the same may be varied in many ways. For example, while generally above-described with respect to 802.11 WLANs, it is understood that other example embodiments of the present invention may be applied to WLANs operating in accordance with any wireless communication protocol (e.g., Bluetooth, 802.16, etc.). Such variations are not to be regarded as a departure from the spirit and scope of the exemplary embodiments of the invention, and all such modifications as would be obvious to one skilled in the art are intended to be included within the scope of the invention.

We claim:

1. A method of generating a polling schedule for a plurality of access points and a plurality of mobile devices within a wireless local area network (WLAN) operating in accordance with a wireless communication protocol, comprising:
first generating a first polling schedule for polling each of the plurality of mobile devices within a first number of time slots, the first polling schedule configured such that the polling for each of the plurality of mobile devices does not allow the plurality of mobile devices to interfere with each other;
first determining, based on the first polling schedule, whether each of the plurality of mobile devices can be polled in fewer time slots than the first number of time slots without interfering with each other; and
second generating a second polling schedule for polling each of the plurality of mobile devices within a second number of time slots if the determining step determines that each of the plurality of mobile devices can be polled in fewer time slots than the first number of time slots, the second polling schedule being a compressed version of the first polling schedule such that the second number of time slots is fewer than the first number of time slots.

2. The method of claim 1, wherein the first generating step comprises:
forming an initial merging matrix based on matrix criteria, the matrix criteria defining the initial merging matrix as including a row for each access point, a column for each mobile device, and a cell at each cross section of the rows and columns.

3. The method of claim 2, wherein the first generating step further comprises:
first assigning identifiers of the mobile devices to the cells such that each identifier is assigned to a cell in a column associated with the mobile device and in a row of the access point handling communication with the mobile device.

4. The method of claim 3, wherein the first generating step further comprises:
second assigning Boolean values to each cell for which the identifiers are not first assigned, wherein each of the Boolean values are assigned such that a first Boolean value is assigned to a cell in a column associated with a mobile device and in a row of an access point, capable of serving the mobile device and not currently serving the mobile device and a second Boolean value is assigned to a cell in a column associated with a mobile device and in a row of an access point not capable of serving the mobile device.

5. The method of claim 4, wherein the first determining step comprises:
evaluating values assigned to a pair of cells in a same row of a first column and a second column to determine if the pair of cells can be compressed based on merging conditions;
first repeating the evaluating step until each row in the first and second columns is evaluated; and
second determining whether the first polling schedule can be compressed based on the results of the repeated evaluating steps.

6. The method of claim 5, wherein the merging conditions include the values assigned to the pair of cells are one of condition (i) a pair of second Boolean values, condition (ii) a pair of first Boolean values, condition (iii) a mobile device identifier and the second Boolean value, and condition (iv) the first Boolean value and the second Boolean value.

7. The method of claim 5, wherein the merging conditions do not include the values assigned to the pair of cells are one of condition (i) the first Boolean value and a mobile device identifier and condition (ii) a pair of mobile device identifiers for different mobile devices.

8. The method of claim 5, wherein the second generating step comprises:
compressing the first column and the second column if the second determining step determines that the first and second columns can be compressed.

9. The method of claim 6, wherein the second generating step comprises:
compressing the first column and the second column if the second determining step determines that the first and second columns can be compressed.

10. The method of claim 9, wherein the compressing step generates a third column based on the first and second columns, the third column replacing the first and second columns in a compressed merging matrix, the third column being assign cell values based on which merging condition is satisfied by the evaluated pair of cells in corresponding rows of the first and second columns.

11. The method of claim 10, wherein the assigned cell value for each row in the third column is the second Boolean value if condition (i) is satisfied, the first Boolean value if condition (ii) is satisfied, the mobile device identifier if condition (iii) is satisfied and the first Boolean value if condition (iv) is satisfied.

12. The method of claim 10, further comprising:
implementing the compressed merging matrix as the second polling schedule by interpreting each column in the compressed merging matrix as one of a plurality of time slots and polling each mobile device in a time slot associated with a column including its assigned mobile device identifier.

13. The method of claim 1, further comprising:
implementing the second polling schedule by polling the plurality of mobile devices in the second number of slots in accordance with the second polling schedule such that mobile devices polled in the same time slot do not interfere with each other.
